(19) United States
(12) Patent Application Publication
(10) Pub. No.: US 2001/0053213 A1
(43) Pub. Date: Dec. 20, 2001

(54) Teleconferencing system and method

(75) Inventors: Hong Linh Truong, Richterswil (CH); Lucas S. Heusler, Zurich (CH); Yann Duponchel, Adliswil (CH); Marcel Graf, Kilchberg (CH); Beat Liver, Adliswil (CH)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 09/855,303

(22) Filed: May 15, 2001

(30) Foreign Application Priority Data
May 17, 2000 (CH) EP - 00110505.5

(51) Int. Cl. H04M 3/42

(52) U.S. Cl. 379/202.01

(57) ABSTRACT

A teleconferencing system comprised of one or more telecommunication systems; two or more subscriber terminals connected to the telecommunication systems; an electronic computing means connected any telecommunication system of the teleconferencing system. The electronic computing means, e.g. a server-type computer runs a conference initiating program; and a means for providing an availability signal associated with each subscriber terminal. The availability signal is accessible to the server and any participating telecommunication system is capable of cooperating with program for initiating a conference between the subscriber terminals; program initiates a conference between the subscriber terminals by attempting transmission of a conference call when such call is requested by any of the subscriber terminals; the conference call is transmitted to each subscriber terminal as soon as its associated availability signal indicates availability of that terminal.

### CROSS REFERENCES

The present application is related to the following application even dated herewith: Attorney docket number CH919990036US 1, patent application No. (to be assigned), entitled, “Presence Information Method and System,” by inventors G. Dermler et al., which is incorporated herein by reference in entirety for all purposes.

### FIELD OF THE INVENTION

The present invention is generally directed to the art of teleconferencing and specifically to improved teleconferencing systems, methods and programs.

### PRIOR ART

Multiparty conferencing is a feature found in the Public Switched Telephone Network (PSTN), in the Integrated Services Digital Network (ISDN), in private telephone networks (PTN), and in IP telephony networks (IPTel). There exist voice conferences which have only an audio session, as well as video conferences which have an audio and a video session. The latter sometimes also include a data collaboration session.

The most common form of setting up a conference-type communication session is to arrange it in advance, e.g. several hours or days before the start of the conference) because the conference needs special resources, for example a conference bridge for mixing various audio and video signals, which may be limited.

For example, reservation may be done by calling an operator, or by filling out a form on a web-site. In other words, the participants of the intended conference must have agreed beforehand on the time when the conference is to take place.

At the time of reservation the number of participants usually has to be specified to reserve the required and appropriate conference bridge. At the actual start of the conference there are two ways in which the participants can join the conference: In the first method, the participants are invited into the conference; typically, they receive a call either by one of the conference participants or by an operator. In the second method the participants are given a specific and unique telephone number, and they join the conference by calling this number.

In the ITU-T Recommendation H.323 [H.323] defines another form of conference called “ad-hoc conference”. With an ad-hoc conferencing a normal call between two participants (a point-to-point call) is expanded into a conference (a multi-participant call). One of the participants who is already present simply calls additional participants which are taken into the conference when they answer the call.

With IP telephony technology—on the other hand—it is possible to hold conference-type communication sessions without special resources, such as a conference bridge. Consequently, there would be no need to arrange for a conference-type session in advance.

“Presence” is a relatively new mode of communication that has recently become very popular in the Internet. “Internet Presence” is a service that allows a user A to declare his interest in the presence information of another user B (he is said to “subscribe” to the presence information of user B). The terminal of user B publishes presence information about user B. The service delivers notifications to A each time the presence information of B changes.

The presence information of a user roughly is information about what the user is currently doing. For example, presence information may include whether or not the user is currently connected to the Internet, whether or not the user is currently having a telephone call, or whether or not the user has interacted with his terminal recently.

Most telephone systems collect presence information about their users for internal purposes, without offering a presence service to their users:

For example, the PSTN (Public Switched Telephone Network) is able to monitor the status of a telephone line of a subscriber and to determine whether the user is busy or not. The event that a telephone line changes from “busy state” to “not busy state” is a piece of presence information. It indicates that during the next seconds there is a high likelihood that the user would be able to answer a call.

Another example is that of a network for mobile telephony which provides a procedure for the mobile cellular telephones to register with the network before the mobile telephone can receive or make a call. The network keeps track of the registration status. The fact that a mobile telephone is registered and not having a call is a piece of presence information.

The standard ECMA-185 “Private Telecommunication Network—Specification, Functional Model and Information Flows—Call Completion Supplementary Services” [ECMA-185] defines two services as “call completion supplementary” services:

(1) Completion of Call to Busy Subscriber (CCBS) and

(2) Completion of Call on No Reply (CCNR).

These services allow to automatically retry a call later in case the called user could not answer, for example because he was on another call (in the case of CCBS), or he was not replying (in the case of CCNR).

The advantage of this type of services is that the system automatically retries the call when the called user is no longer busy (in the case of CCBS as explained below) or when the called user is now known to be available (in the case of CCNR as explained below). A telephone-type communication system accomplishes this by constantly monitoring the line of the called user.

### OBJECTS AND BRIEF SUMMARY OF THE INVENTION.

Accordingly, it is a main object of the invention to provide for a an improved system for initiating a teleconference and/or to facilitate establishing an ad-hoc conference.

Another object of the invention is to enable the use of presence information for improving the results of other types of communication services, such as completion-of-call-on-no-reply, wake-up calls, event notification and other related forms of telecommunication capable of benefiting from evaluation of presence information. Further objects will become apparent as this specification proceeds.

These objects and further advantages will be achieved, according to the invention by a teleconferencing system as specified in claim 1. Preferred forms of the system are defined in claims 2-5 The invention further provides for a teleconferencing method as defined in claims 6 and 7 and a program for initiating teleconferences as defined in claims 8 and 9.

Generally, the teleconferencing system according to the invention comprises at least one telecommunication system and may comprise a plurality of telecommunication services, e.g. a PSTN, an ISDN, an IPTel, a PTN, a mobile telephone system that may but need not be connected to another telephone system; further, the system comprises at least two subscriber terminals which may either be connected to the same telecommunication system, for example, when only one telephone system is involved, or be connected to different networks that are part of the teleconferencing system according to the invention; the system according to the invention includes an electronic computing means, e.g. a server-type computer, connected any participating telecommunication system; the electronic computing means or server, in turn, includes a conference initiating program (also termed “special program” hereinafter).

The teleconferencing system according to the invention further includes means for providing an availability or “presence” signal associated with each subscriber terminal; such means are known per se or disclosed in the cross-referenced, co-pending application, docket number: CH919990036US1, for creating an availability signal in case of the PSTN and cellular telephone networks.

“Association” of the means for providing the availability signal is intended to point to the fact that such means could be an integrated or separate part of the subscriber terminal, or be a feature of the telecommunication system to which the subscriber terminal is connected.

For example, the availability signal can be gained from such presence services as are available in the Internet from various providers (e.g. AOL instant messenger, YAHOO messenger or MSN messenger).

The availability signal must be accessible to the electronic computing means or server computer. In turn, the conference initiating program that is operated by the server computer must be accessible to each subscriber terminal so that the subscriber who operates the subscriber terminal is capable of causing a conference call to any other subscriber terminal as soon as the availability signal of the other subscriber terminal indicates availability. While a conference call can be initiated by any subscriber, this does not preclude that the conference initiating program includes a priority system such that only selected users are capable of initiating a conference call while, on the other hand, all subscribers should be able to obtain the conference call as soon as they are available. In other words, all subscribers could be authorized, or authorization to initiate conference call could be restricted to selected users; obviously, such operating parameters could be administered by the conference initiating program which would normally—i. e. without such a programmable hierarchy—treat all subscriber terminals as equal by keeping track of the availability signal of each subscriber terminal as well as by accepting a conference call from any of them and forwarding it to any of them.

It should be noted in this context that the term “subscriber terminal” and “subscriber” are used synonymously to some extent herein. Obviously, any terminal connected to the respective telecommunication system would become a “subscriber terminal” whenever it is being operated by a person who can identify herself or himself as a subscriber. By the same token, an availability signal from any given subscriber terminal does not necessarily imply that the subscriber is actually “available” in the sense of being physically present. For example, the subscriber could have left the terminal or not be willing or able to perceive the conference call that is exhibited by her/his terminal.

The availability signal must be accessible to the server, and any participating telecommunication system must be capable of cooperating with the special program for initiating a conference between the subscriber terminals. Gateway devices known in the art may be used for this purpose to interconnect any two telecommunication services that participate in the teleconferencing system according to the present invention that but would not be compatible without such a device.

The special program initiates a conference—in the general sense explained above—between the subscriber terminals by attempting transmission of a conference call when such call is requested by any of the subscriber terminals; the conference call is transmitted to each subscriber terminal as soon as its associated availability signal indicates availability of that terminal.

In a second general embodiment, the present invention provides for a teleconferencing method for use in one or more telecommunication systems. Again, two or more subscriber terminals are connected to the telecommunication system, or systems, and—again—the telecommunication system(s) is/are connected with a server-type computer which operates a conference initiating program and each subscriber terminal generates, or is associated with, with an availability signal. Preferably, at least one of the telecommunication systems is capable of transmitting data streams of differing media, e.g. audio and video.

When a conference call is initiated by an authorized subscriber this call is relayed to any other subscriber terminal as soon as the availability signal indicates it's availability.

Further, the invention provides for a conference initiating program for use in a teleconferencing system formed by one or more telecommunication systems with two or more connected subscriber terminals and a connected server-type computer capable of running the conference initiating program according to the invention. A main function of this program would, of course, be to evaluate the availability signal of all subscriber terminals and to call each subscriber terminal as soon as its availability is indicated.

The term “telecommunication system” as used herein is intended to refer to any specific telecommunication network as well as to any system resulting from interconnection of two or more specific telecommunication networks. Typical and preferred examples of telecommunication systems suitable for the present invention have been cited above.

The term “availability signal” of a terminal is used in the sense of “presence information” and refers to a signal that indicates whether a call to that terminal is possible, i. e. that the terminal is accessible to a call. Such means are known per se for or are subject of our contemporaneously filed, cross-referenced patent application, having Attorney docket number CH919990036US1.

Further, it should be emphasized that the term “teleconferencing” is intended herein to not only include ad-hoc conferencing and similar telecommunications but services of the types mentioned above. In other words, the terms “call” and “conference” as used herein synonymously to designate a communication transaction so that a “call” could also be conceived a “two-party communication transaction” while a “conference” is a communication transaction between more than two parties.

### DETAILED DESCRIPTION OF THE INVENTION

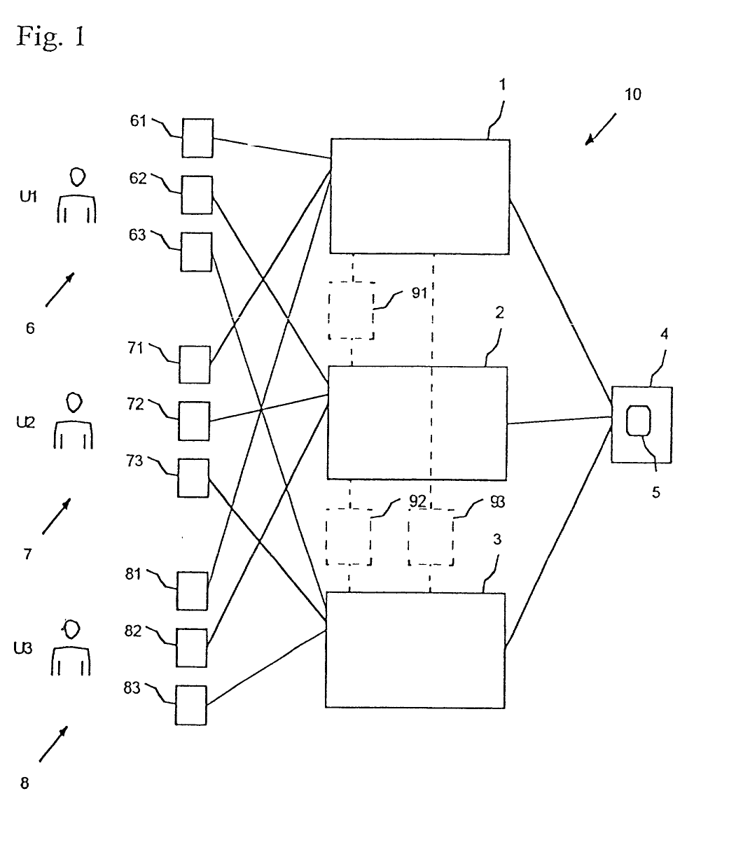

The method of operating a telecommunication system according to the invention as well as such as system will now be explained in more detail with reference to the enclosed drawing in which the only FIG. 1 represent a diagrammatic illustration of the components of a teleconferencing system according to the invention.

Specifically, FIG. 1 shows a diagrammatic presentation of one embodiment of a teleconferencing system (10) according to the invention. It includes three telecommunication systems 1,2,3, e.g. a PSTN, an ISDN, and an IPTel; alternatively or additionally, system 10 could include a PTN, an Internet or an Intranet. Gateways 91, 92, 93 are used to provide interoperability if this is needed for interconnection of systems which would not normally be interoperable.

At least two subscriber terminals 61, 71 are connected to the same or to different telecommunication systems 1,2,3, but, normally, a plurality of subscriber terminals will participate, only three (61,62,63;71,72,73;81,82,83) being represented in FIG. 1. Any of these subscriber terminals could be connected to any telecommunication system 1,2,3. Actual subscribers U₁, U₂, U₃ could have one or more terminals which, when properly operated by the subscriber, e.g. by user identification and/or password, would become “subscriber terminals”. Of course, a subscriber may operate more than one terminal as a subscriber terminal. Non-subscriber terminals connected to systems 1,2,3 could and normally would also be connected to each system 1,2,3 but are not shown in FIG. 1.

Each telecommunication system 1,2,3 that is included in a teleconferencing system 10 according to the invention is, in turn, connected with a server-type computer or equivalent electronic computing device. It is to be noted that the lines shown in FIG. 1 indicate operative connections of any suitable form, e.g. connecting lines of any suitable type or connections by way of infrared or microwave transmission techniques.

Server 4 runs a teleconferencing program 5 which in addition to any normal functions for operation, identification and the like incorporates special functions for receiving and evaluating availability signals from each subscriber terminal, receiving conference call request from any subscriber terminal, optionally evaluating a privilege status, and emitting conference initiation calls to any subscriber terminal as soon as the availability thereof is established by program 5.

When a subscribed user of the conferencing service invokes the conference service, he gives to the system a list of users that are to become participants in a conference. The user may or may not include himself in the list. The system then starts to monitor every subscriber terminal in the list. The system determines for each user from the presence information available from that user if he is likely to participate in the conference and invites each user by placing a call to him.

A main benefit of the invention for conferencing is that the conference participants do not have to wait for each other. They are only alerted when the system has determined for all prospective participants a high probability to be available.

In the beginning, the conference with a system according to the invention is in a state in which some users are already participating in the conference (because they answered the call) while other users are still being alerted. It is up to the users already present to decide if they want to start the conference conversation or wait for other users to join. Some users may actually never answer the call because the conferencing service according to the invention does not guarantee that an available subscriber will actually enter into communication.

Thus, the conference may never reach the state where all prospective participants have joined. This is not an abnormal situation. If the participants decide to wait for others and to postpone the conference, one of the participants simply invokes the service again. To prevent the service from immediately starting the conference again, the service subscriber has the option to raise the bar on the criterion for the availability of a user.

The availability or presence information that the system has of a user may come from a variety of sources, as mentioned above, e.g.

from monitoring a PSTN, ISDN or PTN telephone line,

from the network registration of a mobile phone,

from a terminal that is part of an Internet presence service.

### EXAMPLES

The following examples of an operation of a system according to the invention are intended for illustration and not limitation.

### Example 1

This example illustrates the case of a multiple telecommunication systems with no gateways for use according to the invention:

First step: user A—a subscriber to the conference call system according to the invention—makes a call to user B using telecommunication system 1 but user B—also a subscriber to the conference call system does not answer.

Second step: user A requests the conference initiating program to connect him to user B.

Third step: the conference initiating program starts to process availability signals from A's and B's terminals.

Fourth step: a terminal of user A becomes available which is connected to telecommunication systems 1 and 2, and the conference initiating program receives a corresponding availability signal.

Fifth step: a terminal of user B becomes available which is connected to telecommunication systems 2 and 3 and the conference initiating program receives a corresponding availability signal.

Sixth step: the conference initiating program detects that a terminal of user A and a terminal of user B are available and connected to the common telecommunication system, i.e. communication system 2, and initiates a call or two-party conference between these terminals using telecommunication system 2.

The sequence explained in this example will initiate a multiparty conference in the same manner by corresponding repetitions for calling additional subscriber terminals.

### Example 2

This example illustrates the case of several interconnected communication systems, i.e. telecommunication system 1 and 2 interconnected by means of a gateway.

First step: as in Example 1.

Second step: as in Example 1

Third step: as in Example 1.

Fourth step: a terminal of user A becomes available which is connected to telecommunication system 1 and the conference initiating program receives a corresponding availability signal.

Fifth step: a terminal of user B becomes available which is connected to telecommunication system 2 and the conference initiating program receives a corresponding availability signal.

Sixth step: the conference initiating program detects that a terminal of user A and a terminal of user B are available and connected to gateway-connected telecommunication systems, and initiates a call—again a two-party conference—between these terminals using telecommunication system 1 and 2 and the gateway.

The sequence explained in this example will initiate a conference in the same manner by repetitions for calling additional subscriber terminals.

The presence or availability information disclosed herein can be generalized to the extent that it is independent of any specific communication services: instead of being available within a specific communication service, a subscribed user could be available at a certain terminal. This kind of availability or presence information could be generated either explicitly by the user himself, e.g. by a registration procedure, or implicitly, by the terminal which “observes” or registers the user's activities which are local at this terminal. Another implicit generation of user presence or availability could be effected by the network which would “observe” or register the user's activities which have an impact upon the network, e.g. making a call.

The presence or availability information can even be generalized to a specific locality. For example, combining with a badge-reading device, the present system can determine the presence of a user within a building or within a specific room.

Based on this generalized aspect, various “completion of call” services can be implemented besides the one described above. Specific examples include the following:

(I) Completion of call on no reply:

User A makes a phone call to user B but B does not answer;

User A requests the system to connect him to user B as soon as B is available; user B is now available at a certain terminal (or in a certain room);

Knowing the capabilities of the terminals at which users A and B are available, the system establishes an appropriate communications means between users A and B. For example, if users A and B are both at a workstation which supports instant messaging, the system pops up a window at A's terminal and tells A that he can now communicate with B via instant messaging.

Similarly, if user B was available in a certain room, the system could determine which terminals are available in this room (e.g. using some database) and then connect user A with user B using the appropriate terminals.

(II) Wake-up calls:

User A requests the system to remind him of a certain event at a certain day and time; at this day and time, the system establishes a call to the terminal at which user A is currently available, using the communication service which is supported by that terminal.

(III) Instant notification:

User A requests the system to notify him immediately when a certain event occurs (e.g. stock price warning, weather warning in outdoor sports activities such as mountain climbing, sailing, canoeing, etc.); when the event happens, the system establishes a call to the terminal at which user A is currently available, using the communications service which is supported by the terminal.

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods. Computer program means or computer program in the present context is meant to include any expression, in any language, code or notation, of a set of instructions intended to cause a system having an information processing capability to perform a particular function either directly or after either or both of the following a) conversion to another language, code or notation; b) reproduction in a different material form.

While various embodiments of the invention have been discussed herein with respect to specific embodiments by way of illustration, not limitation, the scope of the invention is to be construed on the basis of the following claims:

1. A teleconferencing system comprising:
at least one telecommunication system;
at least a first and a second subscriber terminal connected to said telecommunication system;
an electronic computing means connected to said at least one telecommunication system, and
a means for providing an availability signal associated with each of said first and said second subscriber terminal,
said electronic computing means being provided with a conference initiating program, said availability signal being accessible to said electronic computing means, said telecommunication system being capable of cooperating with said conference initiating program for initiating a conference between said subscriber terminals, and said conference initiating program being designed:
to process availability signals of a requesting terminal, and of any and all requested terminals, whenever a conference call is requested by any of said subscriber terminals; and
to initiate a conference call as soon as said availability signals indicate availability of said requesting terminal and of said requested terminals.

2. The system of claim 1, comprising a plurality of telecommunication systems and a multiplicity of subscriber terminals.

3. The system of claim 2, wherein said terminals are connected to different telecommunication systems and wherein said conference initiating program is designed to:
process availability signals of a requesting terminal and of any and all requested terminals whenever a conference call is requested by any of said subscriber terminals; and
to initiate a conference call as soon as said availability signals indicate availability of said requesting terminal and of said requested terminals,
said requesting terminal and said requested terminals being connected to the same telecommunication system.

4. The system of claim 1, comprising a gateway between any two telecommunication systems for mutual interconnection, and wherein said subscriber terminals are connected to different but inter-operable telecommunication systems.

5. The system of claim 4, wherein said conference initiating program is designed to:
process availability signals of a requesting terminal, and of any and all requested terminals, whenever a conference call is requested by any of said subscriber terminals; and
to initiate a conference call as soon as said availability signals indicate availability of said requesting terminal and of said requested terminals,
said requesting terminal and said requested terminals being connected to telecommunication systems that are connected by said gateway.

6. A teleconferencing method for use in at least one telecommunication system connected with at least a first and a second subscriber terminal; said at least one telecommunication system being connected to an electronic computing means provided with a conference initiating program; each of said subscriber terminals being associated with an availability signal; wherein a conference call initiated by one of said first and said second subscriber terminal is relayed to any other subscriber terminal as soon as said availability signal indicates availability of any and all of said subscriber terminals.

7. The method of claim 6, for use in a plurality of telecommunication systems and with a multiplicity of subscriber terminals wherein at least one of said telecommunication systems is capable of transmitting data streams of differing media, e.g. sound and video.

8. A conference initiating program for use in a teleconferencing system comprising:
at least one telecommunication system;
at least a first and a second subscriber terminal connected to said system;
an electronic computing means connected to said at least one telecommunication system;
said electronic computing means being provided with said conference initiating program;
an means for providing an availability signal associated with each of said first and said second subscriber terminal;
said availability signal being accessible to said electronic computing means;
said conference initiating program being accessible to said subscriber terminals and being designed:
to process availability signals of a requesting terminal, and of any and all requested terminals whenever a conference call is requested by any of said subscriber terminals; and
to initiated a conference call as soon as said availability signals indicate availability of said requesting terminal and of said requested terminals.

9. The program of claim 8, said program being designed for accessibility to a plurality of differing telecommunication systems and a multiplicity of subscriber terminals wherein at least one of said telecommunication systems is capable of transmitting data streams of differing media, e.g. sound and video.

10. An article of manufacture comprising a computer usable medium having computer readable program code means embodied therein for causing teleconferencing, the computer readable program code means in said article of manufacture comprising computer readable program code means for causing a computer to effect the steps of claim 6.
